(19) United States
(12) Patent Application Publication
(10) Pub. No.: US 2025/0068682 A1
(43) Pub. Date: Feb. 27, 2025

(54) REFINED SEARCH RESOLUTION BASED ON CAUSAL MAPPING USING REAL TIME DATA

(71) Applicant: Optum, Inc., Minnetonka, MN (US)

(72) Inventors: Ketki Savle, Atlanta, GA (US); Ayush Tomar, Morgan Hill, CA (US); Yizhao Ni, Centennial, CO (US); Ryan Daniel Grossman, Rocky Hill, CT (US)

(21) Appl. No.: 18/500,664

(22) Filed: Nov. 2, 2023

Related U.S. Application Data
(60) Provisional application No. 63/578,455, filed on Aug. 24, 2023.

(51) Int. Cl. G06F 16/9532; G06F 16/9537; G06F 16/9538

(52) U.S. Cl. CPC G06F 16/9532; G06F 16/9537; G06F 16/9538

(57) ABSTRACT

Various embodiments of the present disclosure provide computer interpretation techniques for implementing a query resolution process to improve upon traditional search resolutions within a search domain. The techniques may include receiving a plurality of interaction data objects comprising a plurality of assessment codes and a plurality of intervention codes. The techniques may include generating a frequency distribution comprising a plurality of code pairs based on a plurality of cooccurrences of the plurality of assessment codes and the plurality of intervention codes within the plurality of interaction data objects. The techniques may include generating, using the frequency distribution, a cross-code dataset comprising one or more mapped code pairs from the plurality of code pairs based on a threshold cooccurrence value. The techniques may include initiating the performance of a query resolution operation for a search query based on the cross-code dataset.

### CROSS-REFERENCE TO RELATED APPLICATIONS

This application claims the benefit of U.S. Provisional Application No. 63/578,455, entitled “Utilizing Causal Relationship Between ICD And CPT Codes To Create Guided Provider Search Experience,” and filed Aug. 24, 2023, the entire contents of which are herein incorporated by reference.

### BACKGROUND

Various embodiments of the present disclosure address technical challenges related to search query resolutions generally and, more specifically, the performance of causal query resolutions in complex search domains. Traditionally, search engines are limited to the context or search string provided by a user. In complex search domains, such as clinical domains in which users may require on professional assistance to understand searchable options for a particular condition, contextual or explicit information provided by a user may be misleading, incomplete, or inefficiently capture the underlying intent for a search query. As an example, for a clinical domain, if a user is suffering from an anxiety disorder, then the user may intend to search for a healthcare provider that specializes in treating anxiety disorders, such as psychotherapists. However, due to a lack of knowledge of the various clinical specialties with a clinical domain, the user may enter a search descriptive of their particular anxiety disorder and, in return, a search engine may provide results related to anxiety disorders rather than treatments or specialties for handling the searched disorder. This, in turn, may cause users to rely on professional guidance, through multiple clinical sessions scheduled through irrelevant search results, to establish meaningful connections between their conditions and corresponding treatments.

Traditional search engines, such as Centers for Medicare and Medicaid Services (CMS), licensed American Medical Association (AMA), and/or the like, are limited to causal relationships between multiple conditions. While helpful in expanding the breadth of search results, sets of descriptions of causally related conditions exist separate from the procedures that may solve the intent behind a clinical query. By expanding search results, traditional search engines may increase a user's burden by providing additional potential conditions to take into account, without offering solutions to any of the provided conditions.

Moreover, traditional search engines rely on syntactic similarities between a search query and potential results. Such syntactic-based search techniques fail to account for causal relationships between related types of search results, such as diagnosis and related procedures, associated with a search query which results in poor retrieval performance. Retrieval performance may be particularly poor in search domains with semantic result mappings, such as in a clinical domain where a diagnosis may not have any semantic relation to a procedure complicating the retrieval of specific healthcare providers related to a procedure in response to a search query referencing a diagnosis.

Various embodiments of the present disclosure make important contributions to traditional search query resolution techniques by addressing each of these technical challenges.

### BRIEF SUMMARY

Various embodiments of the present disclosure provide automated solutions to intelligently map related codes in a search domain to improve traditional search query resolutions. Using some of the techniques of the present disclosure, related codes, such as diagnosis codes and procedure codes in a clinical domain, may be causally mapped to each other based on historical correlations derived from their use across a population and within a particular time interval. By doing so, a cross-code dataset of mapped code pairs may be automatically generated for a search domain. As described herein, a cross-code dataset may be leveraged to improve retrieval operations in search engines for any search domain by enabling the production of search resolution for solving a user intent behind a search query without explicit instructions within a search query.

In some embodiments, a computer-implemented method includes receiving, by one or more processors, a plurality of interaction data objects comprising a plurality of assessment codes and a plurality of intervention codes; generating, by the one or more processors, a frequency distribution comprising a plurality of code pairs based on a plurality of cooccurrences of the plurality of assessment codes and the plurality of intervention codes within the plurality of interaction data objects; generating, by the one or more processors and using the frequency distribution, a cross-code dataset comprising one or more mapped code pairs from the plurality of code pairs based on a threshold cooccurrence value; and initiating, by the one or more processors, the performance of a query resolution operation for a search query based on the cross-code dataset.

In some embodiments, a computing system comprises memory and one or more processors communicatively coupled to the memory, the one or more processors are configured to receive a plurality of interaction data objects comprising a plurality of assessment codes and a plurality of intervention codes; generate a frequency distribution comprising a plurality of code pairs based on a plurality of cooccurrences of the plurality of assessment codes and the plurality of intervention codes within the plurality of interaction data objects; generate, using the frequency distribution, a cross-code dataset comprising one or more mapped code pairs from the plurality of code pairs based on a threshold cooccurrence value; and initiate the performance of a query resolution operation for a search query based on the cross-code dataset.

In some embodiments, one or more non-transitory computer-readable storage media includes instructions that, when executed by one or more processors, cause the one or more processors to receive a plurality of interaction data objects comprising a plurality of assessment codes and a plurality of intervention codes; generate a frequency distribution comprising a plurality of code pairs based on a plurality of cooccurrences of the plurality of assessment codes and the plurality of intervention codes within the plurality of interaction data objects; generate, using the frequency distribution, a cross-code dataset comprising one or more mapped code pairs from the plurality of code pairs based on a threshold cooccurrence value; and initiate the performance of a query resolution operation for a search query based on the cross-code dataset.

### BRIEF DESCRIPTION OF DRAWINGS

FIG. 1 illustrates an example computing system in accordance with one or more embodiments of the present disclosure.

FIG. 2 is a schematic diagram showing a system computing architecture in accordance with one or more embodiments of the present disclosure.

FIG. 3 is a dataflow diagram showing example data structures and modules for facilitating a cross-code mapping technique in accordance with some embodiments discussed herein.

FIG. 4 is a dataflow diagram showing example data structures and modules for a query resolution operation technique in accordance with some embodiments discussed herein.

FIG. 5 is a flowchart showing an example of a process for generating a cross code dataset in accordance with some embodiments discussed herein.

FIG. 6 is a flowchart showing an example of a process for performance of a query resolution operation using a cross-code dataset in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not indicate being based only on or based solely on the referenced element or elements unless so indicated. Like numbers refer to like elements throughout. Moreover, while certain embodiments of the present disclosure are described with reference to predictive data analysis, one of ordinary skills in the art will recognize that the disclosed concepts may be used to perform other types of data analysis.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like). A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

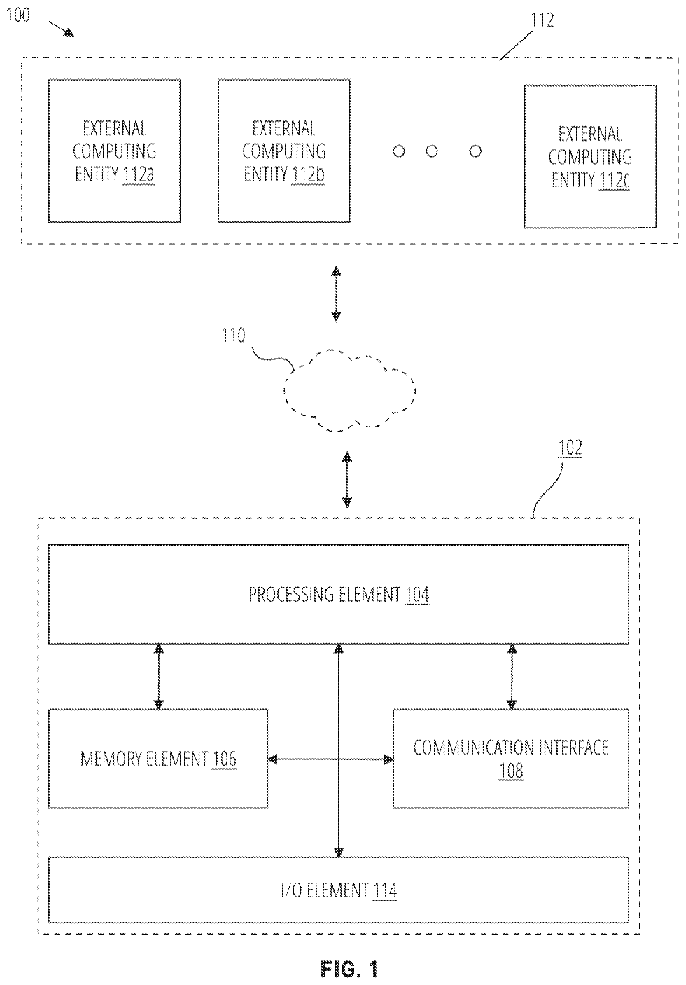

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., mapping techniques, query resolution techniques, and/or the like) described herein.

The external computing entities 112a-c, for example, may include and/or be associated with one or more entities that may be configured to receive, store, manage, and/or facilitate datasets, such as interaction datasets, taxonomy datasets, and/or the like. The external computing entities 112a-c may provide such datasets, and/or the like to the predictive computing entity 102 which may leverage the datasets to process query resolution operations. In some examples, the datasets may include an aggregation of data from across the external computing entities 112a-c into one or more aggregated datasets. The external computing entities 112a-c, for example, may be associated with one or more data repositories, cloud platforms, compute nodes, organizations, and/or the like, that may be individually and/or collectively leveraged by the predictive computing entity 102 to obtain and aggregate data for a search domain.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

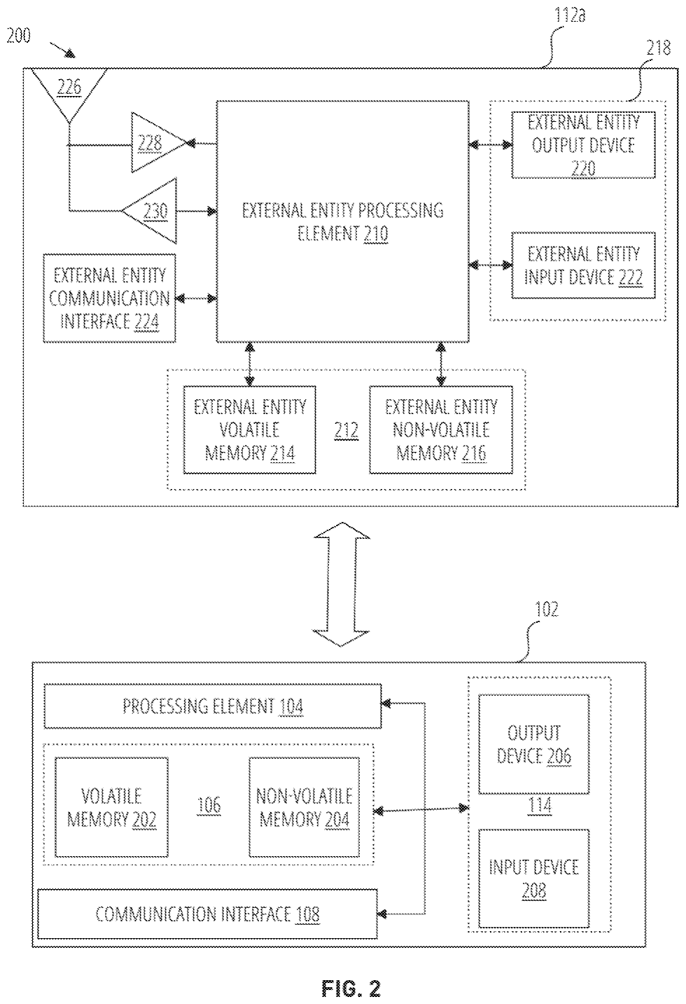

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more steps/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product which includes non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something with inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “interaction data object” refers to a data entity that includes information representative of a recorded interaction. In some examples, an interaction data object may include a recorded interaction for an individual. An interaction data object may include a plurality of attributes indicative of one or more characteristics of the recorded interaction. The plurality of attributes, for example, may include one or more alpha-numerical codes that designate a particular aspect of an interaction. In some examples, an interaction data object may include a plurality of cooccurring codes associated with a particular interaction, time interval, individual, unique identifier, and/or the like. In addition, or alternatively, an interaction data object may include one or more contextual attributes, such as individual attributes (e.g., demographic, location, name, and/or other characteristics for an individual associated with an interaction data object, etc.), provider attributes (e.g., provider name, location, and/or other characteristics for a provider associated with an interaction data object, etc.), and/or the like.

In some embodiments, an interaction data object depends on a search domain. For example, in a clinical domain, an interaction data object may include a medical claim for a patient that is issued by a healthcare provider. In such a case, an interaction data object may include a plurality of attributes that are indicative (e.g., including identifiers, etc.) of one or more healthcare claim feature values that describe at least one of a healthcare claim's procedure type, diagnosis, medical equipment, insurer requirements, physician deadlines, and/or the like. In some examples, an interaction data object may include provider attributes related a healthcare provider. In some examples, an interaction data object may include one or more medical codes, such as international classification of diseases (ICD) codes, current procedural terminology (CPT) codes, and/or the like. By way of example, an interaction data object may include two medical codes that are included in a single medical claim indicating that the two codes were billed together in the medical claim. A plurality of codes identified within one or more interaction data objects may be identified as cooccurring. Cooccurring codes may be used to gain insights into the respective codes. For example, if two cooccurring codes respectively designate a diagnosis and a procedure, it may be that the diagnosis and procedure are related.

In some embodiments, an interaction data object includes one or more assessment codes and/or intervention codes. As described herein, the one or more assessment and/or intervention codes may be correlated to identify cooccurring codes within an interaction data object. The cooccurring codes may identify a correlation between an assessment (e.g., corresponding to an assessment code) and/or an intervention (e.g., corresponding to an intervention code).

In some embodiments, the term “assessment code” refers to a data entity that identifies a first insight for an individual. For example, an assessment code may be indicative (e.g., include an identifier, etc.) of a condition. The condition, for example, may include a diagnosed condition for an individual. By way of example, an assessment code may include a numeric, alpha-numeric, and/or the like code that may identify a defined condition.

In some embodiments, an assessment code is based on a search domain. For example, in clinical domain, an assessment code may be a diagnosis code received and/or defined from a plurality of information sources (e.g., code taxonomies, etc.). By way of example, in a clinical domain, an assessment code may include an ICD-10, ICD-11, and/or the like, code from an international dataset of defined diagnosis codes.

In some embodiments, an assessment code is one of a plurality of assessment codes that are identified from a plurality of interaction data objects over a particular time interval. The plurality of assessment codes, for example, may include a subset of ICD codes that are used with a particular time interval. For instance, the plurality of assessment codes may be based on a plurality of interaction data objects across a population of individuals. For example, in a clinical domain, the interaction data objects may include a plurality of medical claims accessed from electronic health records (EHR) for the population of individuals. By way of example, an assessment code may be an ICD code referenced by one or more medial claims across a population of users over a time interval. In some examples, a plurality of interaction data objects may include a list of assessment codes, such as ICD-10-CM codes, and/or the like, that are recorded for an individual during a time interval. In some examples, each assessment code may correspond to an event for an individual. The event, for example, may include a diagnosis for a disease corresponding to the assessment code. In some examples, the presence of an assessment code within a plurality of interaction data objects may be indicative (e.g., including one or more identifiers, textual description, etc.) of the occurrence of an event (e.g., a disease diagnosis) for an individual within a historical time interval.

In some embodiments, an assessment code is associated with a textual description that describes, elaborates, and/or details a condition identified by the assessment code. The textual description, for example, may include contextual information, such as medically relevant information in a clinical domain, for the assessment code. For example, the assessment code may have a standardized textual description explaining relevant clinical information such as the name, causes, symptoms, history, treatments, abnormal findings, etc., of a corresponding diagnosis and/or the like. In this manner, an assessment code may be used to identify contextual information, such as medically relevant information in a clinical domain, relating to an event recorded by an assessment code within an interaction data object.

In some embodiments, the term “primary assessment code” refers to a particular assessment code from an interaction data object. A primary assessment code, for example, may include a most relevant assessment code for an interaction data object from a list of assessment codes identified by the interaction data object. In some examples, the primary assessment code may include a first listed assessment code within the list of assessment codes. For instance, in a clinical domain, a primary assessment code may be considered as the primary reason for a visit to a healthcare provider and the best source to understand what the healthcare provider diagnosed as the primary issue in the visit. In some examples, a primary assessment code may include a first assessment code listed in a medical claim, such as, for example, a first ICD code in a medical claim. In some examples, as described herein, a primary assessment code may be extracted from a plurality of interaction data objects to identify a plurality of assessment codes within a time interval. The primary assessment codes may be leveraged to generate one or more code pairs and/or other predictive insights for a search domain.

In some embodiments, the term “intervention code” refers to a data entity that identifies a second insight for an individual. For example, an intervention code may be indicative (e.g., include an identifier, etc.) of an action. The action, for example, may include an action taken in response to a condition of an individual. By way of example, an intervention code may include a numeric, alpha-numeric, and/or the like code that may identify a defined action.

In some embodiments, an intervention code is based on a search domain. For example, in clinical domain, an intervention code may be a procedure code received and/or defined from a plurality of information sources (e.g., code taxonomies, etc.). By way of example, in a clinical domain, an intervention code may include a CPT, HCPCS, and/or the like, code from an international dataset of defined procedure codes.

In some embodiments, an intervention code is one of a plurality of intervention codes that are identified from a plurality of interaction data objects over a particular time interval. The plurality of intervention codes, for example, may include a subset of CPT codes that are used with a particular time interval. For instance, the plurality of intervention codes may be based on a plurality of interaction data objects across a population of individuals. For example, in a clinical domain, the interaction data objects may include a plurality of medical claims accessed from electronic health records (EHR) for the population of individuals. By way of example, an intervention code may be a CPT code referenced by one or more medial claims across a population of users over a time interval. In some examples, a plurality of interaction data objects may include a list of intervention codes, such as CPT codes, and/or the like, that are recorded for an individual during a time interval. In some examples, each intervention code may correspond to an event for an individual. The event, for example, may include a procedure for treatment of a disease corresponding to the intervention code. In some examples, the presence of an intervention code within a plurality of interaction data objects may be indicative of (e.g., include an identifier identifying, etc.) the occurrence of an event (e.g., a procedure) for an individual within a historical time interval.

In some embodiments, an intervention code is associated with a textual description that describes, elaborates, and/or details an action identified by the intervention code. The textual description, for example, may include contextual information, such as medically relevant information in a clinical domain, for the intervention code. For example, the intervention code may have a standardized textual description explaining relevant clinical information such as the name, uses, symptoms, history, methods, abnormal findings, etc., of a corresponding procedure and/or the like. In this manner, an intervention code may be used to identify contextual information, such as medically relevant information in a clinical domain, relating to an event recorded by an intervention code within an interaction data object.

In some embodiments, the term “primary intervention code” refers to a particular intervention code from an interaction data object. A primary intervention code, for example, may include a most relevant intervention code for an interaction data object from a list of intervention codes identified by the interaction data object. In some examples, the primary intervention code may include a first listed intervention code within the list of intervention codes. For instance, in a clinical domain, a primary intervention code may be considered as the primary reason for a visit to a healthcare provider and the best source to understand what the healthcare provider provided for the primary issue in the visit. In some examples, a primary intervention code may include a first intervention code listed in a medical claim, such as, for example, a first CPT code in a medical claim. In some examples, as described herein, a primary intervention code may be extracted from a plurality of interaction data objects to identify a plurality of intervention codes within a time interval. The primary intervention codes may be leveraged to generate one or more code pairs and/or other predictive insights for a search domain.

In some embodiments, the term “textual description” refers to semantic content that elaborates on a meaning, purpose, and/or context of a data entity, such as an assessment and/or intervention code. A textual description may be based on a search domain. For example, in a clinical domain, a textual description may include clinically relevant information. For instance, a textual description may be a standardized and/or non-standardized description associated with a particular code, listing, and/or the like. In some examples, a textual description may be a description associated with a particular assessment code (e.g., ICD-10 code, etc.), intervention code (CPT code, etc.), and/or the like. In some examples, a textual description includes a natural language and/or structured language textual description associated with a particular assessment code, intervention code, and/or the like.

In some embodiments, the term “code pair” refers to a data entity that identifies a code tuple including a plurality of related codes. For example, a code pair may identify a pair of two codes including a first code, such as a particular assessment code, and a second related code, such as an intervention code. A code pair, for example, may include an assessment code and an intervention code that cooccur within an interaction data object. For instance, an interaction data object may include one or more cooccurring codes associated with a particular interaction, time interval, individual, unique identifier, and/or the like. In some examples, a code pair may include two cooccurring code identified within an interaction data object.

In some embodiments, a code pair is identified from each of a plurality of interaction data objects to generate a plurality of code pairs corresponding to a plurality of interaction data objects. A code pair identified from an interaction data object may include an assessment code (e.g., a primary assessment code, etc.) and/or an intervention code (e.g., primary intervention code, etc.).

A code pair may be indicative (e.g., include multiple identifiers, etc.) of two different codes that are associated with a common event. A common event, for example, may depend on a search domain. For instance, in a clinical domain, during a particular visit, a patient may receive a diagnosis followed by a procedure for the diagnosed condition. In such a case, an assessment code indicative (e.g., including an identifier, etc.) of the diagnosis and an intervention code indicative (e.g., including an identifier, etc.) of the procedure may be recorded in an interaction data object for the particular visit. A code pair identified from the interaction data object for the particular visit may include the assessment code and the intervention code to represent a relationship between the diagnosis and the procedure.

In some embodiments, the term “frequency distribution” refers to a data entity that describes a measure of occurrences in which one or more variables takes each of their possible values. A frequency distribution may describe a measure of a plurality of code pairs. A frequency distribution may describe a measure of cooccurring assessment codes and intervention codes identified within a plurality of interaction data objects. A frequency distribution may describe a measure of a plurality of code pairs by, for example, counting the number of occurrences of each possible code pair within the plurality of code pairs. A frequency distribution may be used to gain insights for the variables which the frequency distribution measures. For example, a frequency distribution may be used to identify relatively commonly occurring code pairs. By measuring a plurality of code pairs, a frequency distribution may be used, for example, to identify which code pairs occur the most, the least, more frequently than others, more frequently than a set threshold, within a select range, etc.

In some embodiments, the term “threshold cooccurrence value” refers to a threshold metric associated with a frequency distribution. A threshold cooccurrence value, for example, may include a static and/or dynamic value, range of values, and/or the like that defines a target frequency for a code pair within a frequency distribution. By way of example, a threshold cooccurrence value may include a static and/or dynamic percentage, such as 10%, 20%, 30%, etc., real number, such as 10, 50, 100, 1000, etc., and/or any other ratio, numeric, and/or the like. In some examples, the threshold cooccurrence value may define a relative frequency percentage, such as a top 20% frequency, for the frequency distribution. In such a case, the code pairs with a frequency within relative frequency percentage (e.g., a top 20%) relative to other code pairs within the frequency distribution may satisfy the threshold cooccurrence value. In some examples, an assessment code and an intervention code from a code pair may be mapped to each other in the event that the code pair satisfies the threshold cooccurrence value.

In some embodiments, a threshold cooccurrence value is used to identify a plurality of mapped code pairs conditioned on one of two code types of the code pairs rather than considering the overall most frequent code pairs. For example, a threshold cooccurrence value may include a relative frequency percentage (e.g., a top 20% with respect to all code pairs for a particular assessment code, interaction code, etc.) that is relative a plurality of code pairs for a first code (e.g., an assessment code, etc.) shared by the plurality of code pairs. By way of example, a relative frequency percentage may include a relative frequency percentage, such as a top 20%, that is relative to all code pairs for a particular assessment code. In this manner, each code pair including a particular assessment code may be considered together against a threshold cooccurrence value rather than considering all code pairs. By doing so, an increased number of mapped code pairs may be generated, and issues related to relative differences in frequency may be mitigated. For example, in a case where there are many code pairs including a first assessment code and few code pairs including a second assessment code, identifying the overall 20% most frequent code pairs may result in none of the code pairs including the second assessment code becoming mapped code pairs. Alternatively, if conditioned on each of the plurality of assessment codes, then the 20% most frequently occurring code pairs including the first assessment code may be identified to become mapped code pairs, and additionally, the 20% most frequently occurring code pairs including the second assessment code may be identified to become mapped code pairs.

In some embodiments, the term “mapped code pair” refers to a relevant code pair from a plurality of code pairs. For example, a mapped code pair may be identified from a frequency distribution in the event that the mapped code pair satisfies a threshold cooccurrence value.

In some embodiments, a mapped code pair includes a first textual description associated with a respective assessment code and second textual description associated with a respective intervention code from a respective code pair. A mapped code pair may include any information from a respective assessment code and/or intervention code from the respective code pair. For example, mapped code pairs may be used to identify which intervention codes are mapped to a particular assessment code, by, for example, identifying one or more intervention codes that are in mapped code pairs with the particular assessment code. A mapped code pair including an assessment code and an intervention code may also include a textual description respective to the assessment code and another textual description respective to the intervention code. In such a case, an assessment code of a mapped code pair may be used to identify the textual description for an intervention code of the same mapped code pair. Generally, information from one code in a mapped code pair may be used to identify any information from the other code of the mapped code pair.

In some embodiments, the term “cross-code dataset” refers to a data entity that includes a plurality of mapped code pairs. A cross-code dataset may be used to identify, retrieve, generate, and/or the like, any information related to the plurality of mapped code pairs. The cross-code dataset may be used to identify information from mapped code pairs based on given information. For instance, a cross-code dataset may be given any information related to one code of a mapped code pair, and in response, identify or provide information related to the other code of the mapped code pair. For example, given a particular assessment code, one or more intervention codes may be identified from mapped code pairs including the particular assessment code. In addition, or alternatively, given a particular assessment code, any information related to one or more intervention codes identified in mapped code pairs including the particular assessment code may be identified and/or provided.

In some embodiments, the cross-code dataset includes a plurality of mapped code pairs that are based on a plurality of interaction data objects associated with a time interval. For instance, the cross-code dataset may include a plurality of mapped code pairs based on a plurality of code pairs including information sourced from interaction data objects that may be associated with a time interval. The time interval, for example, may be based on a refresh rate that defines one or more of one or more historical refresh times, one or more future refresh times, and/or a time period (e.g., a static time period, an event based time period, etc.) between two refresh times. In some examples, the cross-code dataset, mapped code pairs, code pairs, and/or interaction data objects may be continuously or periodically refreshed to generate current data reflective of a population's current behavior. In this manner, the cross-code dataset, mapped code pairs, code pairs, and/or interaction data objects may be adaptively changed over time to accommodate for changes within an environment.

In some embodiments, the term “refresh rate” refers to one or more operations for updating, replacing, and/or regenerating certain data, features, parameters, calculations, and/or the like. For example, a refresh operation may include updating interaction data objects based on new data. In some examples, a refresh operation may include updating code pairs based on new data such as, for example, new textual descriptions, new interaction data objects, and/or the like. In some examples, a refresh operation may include updating mapped code pairs based on a new frequency distribution, threshold cooccurrence value, code pairs, interaction data objects, and/or the like. In some examples, a refresh operation may include updating a cross-code dataset based on a new frequency distribution, threshold cooccurrence value, mapped code pairs, code pairs, interaction data objects, and/or the like.

In some embodiments, a refresh operation may be configured to execute at a certain refresh rate. A refresh rate may be defined by a frequency and/or time interval at which the updating, replacing, and/or regenerating of certain data, features, parameters, calculations, and/or the like may be executed. In some examples, a refresh operation may be performed manually, automatically, and/or algorithmically. For example, a plurality of interaction data objects may be defined by a time interval, such that they may be updated with new interaction data objects at a frequency defined by the time interval. In some examples, one or more features, parameters, calculations, and/or the like, may be refreshed using new parameters, thresholds, underlying data, and/or the like.

In some embodiments, the term “historical refresh time” refers to a historical time interval that at least partially precedes a current time interval. For example, a historical refresh time may be indicative (e.g., including an identifier, etc.) of a time interval corresponding to a historical refresh operation. The historical refresh operation may be executed based on data within the historical refresh time, such as historical interaction data objects that are received and/or dated three months, six months, twelve months, and/or the like before a current time.

In some embodiments, the term “future refresh time” refers to a subsequent time interval that at least partially proceeds a current time interval. For example, a subsequent refresh time may be indicative (e.g., include a time range, etc.) of a time interval corresponding to a subsequent refresh operation (e.g., a planned refresh operation, etc.). The subsequent refresh operation may be executed based on data within the subsequent refresh time, such as subsequent interaction data objects that are received and/or dated for three months, six months, twelve months, and/or the like after a current time.

In some embodiments, the term “query resolution operation” refers to the initiation, execution, and/or processing of a search query. A search query may be a search term or string from a user. A query resolution operation may be the process that executes to return to the user information determined to be most relevant to the user based on the search query. Information determined to be most relevant to the user may be, for example, in the form of one or more codes and/or their related information, an answer, a curated list of facts or details, a suggestion, a link, and/or the like.

In some embodiments, a cross-code dataset may be used in a query resolution operation to identify one or more assessment/intervention codes and/or related information to one or more assessment/intervention codes based on one or more mapped code pairs. For example, a user may input a search query, such as a diagnosis, condition, and/or assessment code, such as an ICD code. In response, a query resolution operation may be initiated using a cross-code dataset. The cross-code dataset may be used to identify one or more mapped code pairs associated with the search query. The cross-code dataset may further be used to identify, based on the one or more identified mapped code pairs, a list of intervention codes, procedures, textual descriptions, and/or any other information based on the mapped code pairs. The information identified using the cross-code dataset may be used as the output or part of the output of the query resolution operation. Additionally, or alternatively, the information identified using the cross-code dataset may be provided for further processing. Additionally, or alternatively, the information identified using the cross-code dataset may be used to identify an intermediate search resolution.

In some embodiments, the term “intermediate search resolution” refers to an intermediate data entity for a query resolution operation. In some examples, an intermediate search resolution includes information related to a search query identified using a cross-code dataset. In some examples, an intermediate search resolution includes information identified from a mapped code pair. For example, given a search query that is related to a particular assessment code, the cross-code dataset may be used to identify one or more intervention codes related to the particular assessment code based on one or more mapped code pairs including the particular assessment code. In some examples, an intermediate search resolution includes one or more intervention codes, assessment codes, procedures, diagnoses, textual descriptions, and/or any other information based on one or more mapped code pairs. The information identified in the intermediate search resolution may be used as the output or part of the output of the query resolution operation. Additionally, or alternatively, the information identified in the intermediate search resolution may be provided for further processing.

In some embodiments, the term “search resolution” refers to a data entity that is an output of a query resolution operation. In some examples, a search resolution includes information related to an intermediate search resolution identified using one or more interactive data objects. In some examples, a search resolution includes information identified from one or more interactive data objects.

For example, given an intermediate search resolution that is related to a particular one or more intervention codes, assessment codes, procedures, diagnoses, textual descriptions, etc., one or more interaction data objects may be used to identify one or more healthcare providers and/or their associated information. For instance, given an intermediate search resolution including a particular intervention code, a plurality of interaction data objects including the particular intervention code may be identified. Using the plurality of identified interaction data objects, one or more healthcare providers may be identified. Then, for example, a search resolution including information based on the one or more identified healthcare providers may be identified. The information identified in the search resolution may be used as the output or part of the output of a query resolution operation. Additionally, or alternatively, the information identified in the search resolution may be provided for further processing.

In some embodiments, the term “search query” refers to a data entity that describes textual information indicative (e.g., include identifiers, textual descriptions, etc.) of a request for information. The textual information may be input by a user through one or more user interfaces (e.g., typed through a keyboard, etc., transcribed from one or more audio inputs, and/or the like). The search query may include a plurality of query terms that are indicative (e.g., including identifiers, textual descriptions, etc.) of one or more features of the search query.

In some embodiments, the term “query term” refers to a data entity that describes a unit of text from a search query. A query term may include a keyword, phrase, and/or the like from the search query. By way of example, a query term may include one or more words and/or phrases extracted from the search query using one or more text extraction techniques (e.g., machine learning extraction models, rule-based extraction models, and/or the like).

### IV. Overview

Embodiments of the present disclosure present mapping and query resolution techniques that improve computer interpretation through causally mapping code pairs, such as assessment codes and intervention codes, and generating a cross-code dataset. Traditional approaches for resolving queries through semantic matching rely on corpuses of information for a particular search domain that may be defined by generalized information. Such information may be dependent on the knowledge of users, such as subject matter experts, within the search domain and are generalized to accommodate multiple interpretations for general categories with information within the search domain. The generalized nature of traditional techniques leads to a lack of causal relationships being understood and inaccurate query resolutions for search queries needing a causal link between information. These poor results are exacerbated in search domains with dense knowledge bases that are unfamiliar to the users that perform search queries. The computer interpretation techniques of the present disclosure intelligently map cooccurring code pairs identified within interaction data objects to accommodate for intelligence gaps in a population of users. By doing so, a cross-code dataset may be generated that includes mapped code pairs to reduce information gaps and improve retrieval options and the accuracy of query resolutions for search queries. Ultimately, the computer interpretation techniques of the present disclosure may be practically applied to improve the performance of traditional query engines.

In some embodiments, a cross-code dataset may be generated for any search domain by intelligently mapping cooccurring code pairs identified in interaction data objects. For example, in a clinical domain, a cross-code dataset including mapped code pairs may be generated using a frequency distribution. By doing so, related diagnoses defined by assessment codes and procedures defined by intervention codes may become mapped and searchable in a way not traditionally available to existing search engines. A search engine may leverage the cross-code dataset to generate more relevant connections between a search query including a diagnosis and its related procedures, and healthcare providers related to such procedures, which may reduce information gaps and improve retrieval options and the accuracy of query resolutions for search queries-even if the query terms are outside of manually curated keywords.

In some embodiments, the interpretation techniques of the present disclosure may be performed automatically using one or more computer automation techniques. For instance, using some of the techniques of the present disclosure, relationships between cooccurring assessment codes and intervention codes may be automatically mapped using a frequency distribution. This, in turn, reduces manual interventions while building specialty mappings that are easily scalable and modifiable. For instance, computer automation algorithms may be leveraged to enhance, monitor, and refresh a cross-code dataset. In this way, quick and accurate information mapping may be performed with minimum human efforts in the loop.

Moreover, some of the techniques of the present disclosure leverage up-to-date data to refine a cross-code dataset to accommodate changes in behavior of a population of users that perform search queries. For instance, a cross-code dataset may be generated using interaction data objects reflective of population interactions over time. In some embodiments, the interaction data objects may be continuously refined, updated, and/or refreshed to generate current data reflective of a population's current behavior. This data may be leveraged to intelligently map code pairs for a cross-code dataset with respect a current population's anticipated requirements. By doing so, some techniques of the present disclosure improve upon static datasets that are prone to output out-of-date results that are irrelevant to a particular search query.

Examples of technologically advantageous embodiments of the present disclosure include: (i) mapping techniques for generating cross-code datasets to improve search engine performance; (ii) search resolution techniques for leveraging cross-code datasets to generate improved search resolutions, among others. Other technical improvements and advantages may be realized by one of ordinary skill in the art.

### V. Example System Operations

As indicated, various embodiments of the present disclosure make important technical contributions to computer interpretation and query resolution technologies. In particular, systems and methods are disclosed herein that present mapping techniques for generating cross-code datasets to improve search engine performance and search resolution techniques for leveraging cross-code datasets to generate improved search resolutions. Unlike traditional query resolution techniques, the mapping techniques of the present disclosure leverage a cross-code dataset to generate more relevant connections for a search query, which may reduce information gaps and improve retrieval operations and the accuracy of query resolutions for search queries in various search domains.

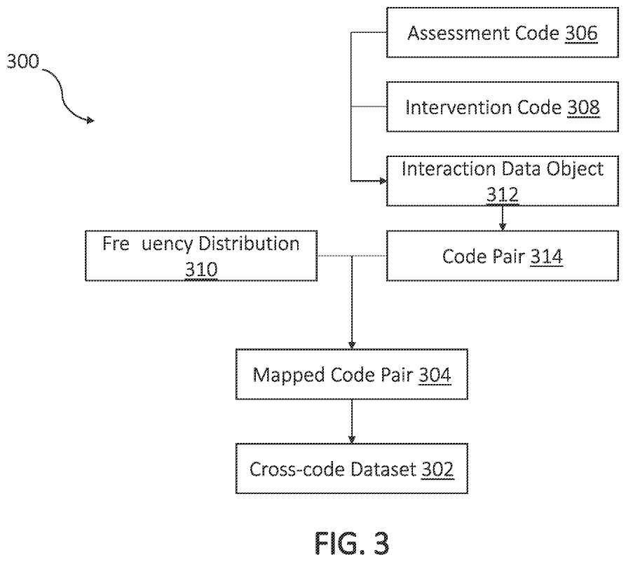

FIG. 3 is a dataflow diagram 300 showing example data structures and modules for facilitating a cross-code mapping technique in accordance with some embodiments discussed herein. The dataflow diagram 300 depicts an intelligent mapping process for generating a cross-code dataset 302 from a plurality of mapped code pairs 304 by intelligently mapping a plurality of assessment codes 306 and a plurality of intervention codes 308 based on a frequency distribution 310. As described herein, the frequency distribution 310 may be generated using a plurality of interaction data objects 312 associated with a population of users to tailor the cross-code dataset 302 the users (and/or trends thereof) within a particular search domain.

In some embodiments, a plurality of interaction data objects 312 is received for a search domain. In some examples, the plurality of interaction data objects 312 may include a plurality of assessment codes 306 and/or a plurality of intervention codes 308.

In some embodiments, an interaction data object 312 is a data entity that includes information representative of a recorded interaction. In some examples, an interaction data object 312 may include a recorded interaction for an individual. An interaction data object 312 may include a plurality of attributes indicative (e.g., including attribute identifiers, etc.) of one or more characteristics of the recorded interaction. The plurality of attributes, for example, may include one or more alpha-numerical codes that designate a particular aspect of an interaction. In some examples, an interaction data object 312 may include a plurality of cooccurring codes associated with a particular interaction, time interval, individual, unique identifier, and/or the like. In addition, or alternatively, an interaction data object 312 may include one or more contextual attributes, such as individual attributes (e.g., demographic, location, name, and/or other characteristics for an individual associated with an interaction data object 312, etc.), provider attributes (e.g., provider name, location, and/or other characteristics for a provider associated with an interaction data object 312, etc.), and/or the like.

In some embodiments, an interaction data object 312 depends on a search domain. For example, in a clinical domain, an interaction data object 312 may include a medical claim for a patient that is issued by a healthcare provider. In such a case, an interaction data object 312 may include a plurality of attributes that are indicative (e.g., including attribute identifiers, etc.) of one or more healthcare claim feature values that describe at least one of a healthcare claim's procedure type, diagnosis, medical equipment, insurer requirements, physician deadlines, and/or the like. In some examples, an interaction data object 312 may include provider attributes related a healthcare provider. In some examples, an interaction data object 312 may include one or more medical codes, such as international classification of diseases (ICD) codes, current procedural terminology (CPT) codes, and/or the like. By way of example, an interaction data object 312 may include two medical codes that are included in a single medical claim indicating that the two codes were billed together in the medical claim. A plurality of codes identified within one or more interaction data objects 312 may be identified as cooccurring. Cooccurring codes may be used to gain insights into the respective codes. For example, if two cooccurring codes respectively designate a diagnosis and a procedure, it may be that the diagnosis and procedure are related.

In some embodiments, an interaction data object 312 includes one or more assessment codes 306 and/or intervention codes 308. As described herein, the one or more assessment codes 306 and/or intervention codes 308 may be correlated to identify cooccurring codes within an interaction data object 312. The cooccurring codes may identify a correlation between an assessment (e.g., corresponding to an assessment code 306) and/or an intervention (e.g., corresponding to an intervention code 308).

In some embodiments, an assessment code 306 is a data entity that identifies a first insight for an individual. For example, an assessment code 306 may be indicative (e.g., include identifiers, etc.) of a condition. The condition, for example, may include a diagnosed condition for an individual. By way of example, an assessment code 306 may include a numeric, alpha-numeric, and/or the like code that may identify a defined condition.

In some embodiments, an assessment code 306 is based on a search domain. For example, in clinical domain, an assessment code 306 may be a diagnosis code received and/or defined from a plurality of information sources (e.g., code taxonomies, etc.). By way of example, in a clinical domain, an assessment code 306 may include an ICD-10, ICD-11, and/or the like, code from an international dataset of defined diagnosis codes.

In some embodiments, an assessment code 306 is one of a plurality of assessment codes 306 that are identified from a plurality of interaction data objects 312 over a particular time interval. The plurality of assessment codes 306, for example, may include a subset of ICD codes that are used with a particular time interval. For instance, the plurality of assessment codes 306 may be based on a plurality of interaction data objects 312 across a population of individuals. For example, in a clinical domain, the interaction data objects 312 may include a plurality of medical claims accessed from electronic health records (EHR) for the population of individuals. By way of example, an assessment code 306 may be an ICD code referenced by one or more medial claims across a population of users over a time interval. In some examples, a plurality of interaction data objects 312 may include a list of assessment codes 306, such as ICD-10-CM codes, and/or the like, that are recorded for an individual during a time interval. In some examples, each assessment code 306 may correspond to an event for an individual. The event, for example, may include a diagnosis for a disease corresponding to the assessment code 306. In some examples, the presence of an assessment code 306 within a plurality of interaction data objects 312 may be indicative (e.g., including identifiers, etc.) of the occurrence of an event (e.g., a disease diagnosis) for an individual within a historical time interval.

In some embodiments, an assessment code 306 is associated with a textual description that describes, elaborates, and/or details a condition identified by the assessment code 306. The textual description, for example, may include contextual information, such as medically relevant information in a clinical domain, for the assessment code 306. For example, the assessment code 306 may have a standardized textual description explaining relevant clinical information such as the name, causes, symptoms, history, treatments, abnormal findings, etc., of a corresponding diagnosis and/or the like. In this manner, an assessment code 306 may be used to identify contextual information, such as medically relevant information in a clinical domain, relating to an event recorded by an assessment code 306 within an interaction data object 312.

In some embodiments, an intervention code 308 is a data entity that identifies a second insight for an individual. For example, an intervention code 308 may be indicative (e.g., including identifiers, etc.) of an action. The action, for example, may include an action taken in response to a condition of an individual. By way of example, an intervention code 308 may include a numeric, alpha-numeric, and/or the like code that may identify a defined action.

In some embodiments, an intervention code 308 is based on a search domain. For example, in clinical domain, an intervention code 308 may be a procedure code received and/or defined from a plurality of information sources (e.g., code taxonomies, etc.). By way of example, in a clinical domain, an intervention code 308 may include a CPT, HCPCS, and/or the like, code from an international dataset of defined procedure codes.

In some embodiments, an intervention code 308 is one of a plurality of intervention codes 308 that are identified from a plurality of interaction data objects 312 over a particular time interval. The plurality of intervention codes 308, for example, may include a subset of CPT codes that are used with a particular time interval. For instance, the plurality of intervention codes 308 may be based on a plurality of interaction data objects 312 across a population of individuals. For example, in a clinical domain, the interaction data objects 312 may include a plurality of medical claims accessed from electronic health records (EHR) for the population of individuals. By way of example, an intervention code 308 may be a CPT code referenced by one or more medial claims across a population of users over a time interval. In some examples, a plurality of interaction data objects 312 may include a list of intervention codes 308, such as CPT codes, and/or the like, that are recorded for an individual during a time interval. In some examples, each intervention code 308 may correspond to an event for an individual. The event, for example, may include a procedure for treatment of a disease corresponding to the intervention code 308. In some examples, the presence of an intervention code 308 within a plurality of interaction data objects 312 may be indicative (e.g., including identifiers, etc.) of the occurrence of an event (e.g., a procedure) for an individual within a historical time interval.

In some embodiments, an intervention code 308 is associated with a textual description that describes, elaborates, and/or details an action identified by the intervention code 308. The textual description, for example, may include contextual information, such as medically relevant information in a clinical domain, for the intervention code 308. For example, the intervention code 308 may have a standardized textual description explaining relevant clinical information such as the name, uses, symptoms, history, methods, abnormal findings, etc., of a corresponding procedure and/or the like. In this manner, an intervention code 308 may be used to identify contextual information, such as medically relevant information in a clinical domain, relating to an event recorded by an intervention code 308 within an interaction data object 312.

In some embodiments, a textual description is semantic content that elaborates on a meaning, purpose, and/or context of a data entity, such as an assessment and/or intervention code 308. A textual description may be based on a search domain. For example, in a clinical domain, a textual description may include clinically relevant information. For instance, a textual description may be a standardized and/or non-standardized description associated with a particular code, listing, and/or the like. In some examples, a textual description may be a description associated with a particular assessment code 306 (e.g., ICD-10 code, etc.), intervention code 308 (CPT code, etc.), and/or the like. In some examples, a textual description includes a natural language and/or structured language textual description associated with a particular assessment code 306, intervention code 308, and/or the like.

In some embodiments, the plurality of interaction data objects 312 is associated with a time interval. In this manner, the plurality of assessment codes 306 and/or intervention codes 308 of the interaction data objects 312 may correspond to a period of time that is defined by a time interval. For example, the time interval may be based on a refresh rate that defines one or more of one or more historical refresh times and/or one or more future refresh times for the interaction data objects 312.

In some embodiments, a refresh rate is one or more operations for updating, replacing, and/or regenerating certain data, features, parameters, calculations, and/or the like. For example, a refresh operation may include updating one or more interaction data objects 312 based on new data. In some examples, a refresh operation may include updating the code pairs 314 based on new data such as, for example, new textual descriptions, new interaction data objects 312, and/or the like. In some examples, a refresh operation may include updating mapped code pairs based on a new frequency distribution 310, threshold cooccurrence value, code pairs 314, interaction data objects 312, and/or the like. In some examples, a refresh operation may include updating a cross-code dataset 302 based on a new frequency distribution 310, threshold cooccurrence value, mapped code pairs 304, code pairs 314, interaction data objects 312, and/or the like.

In some embodiments, a refresh operation may be configured to execute at a certain refresh rate. A refresh rate may be defined by a frequency and/or time interval at which the updating, replacing, and/or regenerating of certain data, features, parameters, calculations, and/or the like may be executed. In some examples, a refresh operation may be performed manually, automatically, and/or algorithmically. For example, a plurality of interaction data objects 312 may be defined by a time interval, such that they may be updated with new interaction data objects 312 at a frequency defined by the time interval. In some examples, one or more features, parameters, calculations, and/or the like, may be refreshed using new parameters, thresholds, underlying data, and/or the like.

In some embodiments, a historical refresh time is a historical time interval that at least partially precedes a current time interval. For example, a historical refresh time may be indicative (e.g., including a time range of, etc.) of a time interval corresponding to a historical refresh operation. The historical refresh operation may be executed based on data within the historical refresh time, such as historical interaction data objects that are received and/or dated three months, six months, twelve months, and/or the like before a current time.

In some embodiments, a future refresh time is a subsequent time interval that at least partially proceeds a current time interval. For example, a subsequent refresh time may be indicative (e.g., including a time range, etc.) of a time interval corresponding to a subsequent refresh operation (e.g., a planned refresh operation, etc.). The subsequent refresh operation may be executed based on data within the subsequent refresh time, such as subsequent interaction data objects that are received and/or dated for three months, six months, twelve months, and/or the like after a current time.

In some embodiments, the plurality of assessment codes 306 and/or the plurality of intervention codes 308 are based on one or more primary assessment codes and/or one or more primary intervention codes. The primary assessment codes and/or intervention codes, for example, may be identified within each of the plurality of interaction data objects 312.

In some embodiments, a primary assessment code is a particular assessment code 306 from an interaction data object 312. A primary assessment code, for example, may include a most relevant assessment code for an interaction data object 312 from a list of assessment codes 306 identified by the interaction data object 312. In some examples, the primary assessment code may include a first listed assessment code within the list of assessment codes 306. For instance, in a clinical domain, a primary assessment code may be considered as the primary reason for a visit to a healthcare provider and the best source to understand what the healthcare provider diagnosed as the primary issue in the visit. In some examples, a primary assessment code may include a first assessment code listed in a medical claim, such as, for example, a first ICD code in a medical claim. In some examples, as described herein, a primary assessment code may be extracted from a plurality of interaction data objects 312 to identify a plurality of assessment codes 306 within a time interval. The primary assessment codes may be leveraged to generate one or more code pairs 314 and/or other predictive insights for a search domain.

In some embodiments, a primary intervention code is a particular intervention code 308 from an interaction data object 312. A primary intervention code, for example, may include a most relevant intervention code for an interaction data object 312 from a list of intervention codes 308 identified by the interaction data object 312. In some examples, the primary intervention code may include a first listed intervention code within the list of intervention codes 308. For instance, in a clinical domain, a primary intervention code may be considered as the primary reason for a visit to a healthcare provider and the best source to understand what the healthcare provider provided for the primary issue in the visit. In some examples, a primary intervention code may include a first intervention code listed in a medical claim, such as, for example, a first CPT code in a medical claim. In some examples, as described herein, a primary intervention code may be extracted from a plurality of interaction data objects 312 to identify a plurality of intervention codes 308 within a time interval. The primary intervention codes may be leveraged to generate one or more code pairs 314 and/or other predictive insights for a search domain.

In some embodiments, a frequency distribution 310 is generated based on a plurality of code pairs 314. The code pairs 314, for example, may be based on a plurality of cooccurrences of the plurality of assessment codes 306 and/or intervention codes 308. The plurality of cooccurrences, for example, may be within the plurality of interaction data objects 312. In some examples, the frequency distribution 310 may include a plurality of code pairs 314 based on a plurality of cooccurrences.

In some embodiments, a code pair 314 is a data entity that identifies a code tuple including a plurality of related codes. For example, a code pair 314 may identify a pair of two codes including a first code, such as a particular assessment code 306, and a second related code, such as an intervention code 308. A code pair 314, for example, may include an assessment code 306 and an intervention code 308 that cooccur within an interaction data object 312. For instance, an interaction data object 312 may include one or more cooccurring codes associated with a particular interaction, time interval, individual, unique identifier, and/or the like. In some examples, a code pair 314 may include two cooccurring code identified within an interaction data object 312.

In some embodiments, a code pair 314 is identified from each of a plurality of interaction data objects 312 to generate a plurality of code pairs 314 corresponding to a plurality of interaction data objects 312. A code pair 314 identified from an interaction data object 312 may include an assessment code 306 (e.g., a primary assessment code, etc.) and/or an intervention code 308 (e.g., primary intervention code, etc.).

A code pair 314 may be indicative (e.g., including multiple identifiers, etc.) of two different codes that are associated with a common event. A common event, for example, may depend on a search domain. For instance, in a clinical domain, during a particular visit, a patient may receive a diagnosis followed by a procedure for the diagnosed condition. In such a case, an assessment code 306 indicative (e.g., including an identifier, etc.) of the diagnosis and an intervention code 308 indicative (e.g., including an identifier, etc.) of the procedure may be recorded in an interaction data object 312 for the particular visit. A code pair 314 identified from the interaction data object 312 for the particular visit may include the assessment code 306 and the intervention code 308 to represent a relationship between the diagnosis and the procedure.

In some embodiments, a frequency distribution 310 is a data entity that describes a measure of occurrences in which one or more variables takes each of their possible values. A frequency distribution 310 may describe a measure of a plurality of code pairs 314. A frequency distribution 310 may describe a measure of cooccurring assessment codes and intervention codes 308 identified within a plurality of interaction data objects 312. A frequency distribution 310 may describe a measure of a plurality of code pairs 314 by, for example, counting the number of occurrences of each possible code pair 314 within the plurality of code pairs 314. A frequency distribution 310 may be used to gain insights for the variables which the frequency distribution 310 measures. For example, a frequency distribution 310 may be used to identify relatively commonly occurring code pairs 314. By measuring a plurality of code pairs 314, a frequency distribution 310 may be used, for example, to identify which code pairs 314 occur the most, the least, more frequently than others, more frequently than a set threshold, within a select range, etc.

In some embodiments, the cross-code dataset 302 is generated using the frequency distribution 310. The cross-code dataset 302, for example, may include one or more mapped code pairs 304 from the plurality of code pairs 314. The one or more mapped code pairs 304, for example, may be based on a threshold cooccurrence value. For example, the cross-code dataset 302 may include a plurality of mapped code pairs 304. The plurality of mapped code pairs 304 may each include a respective assessment code of the plurality of assessment codes 306 and a respective intervention code of the plurality of intervention codes 308. In some examples, the mapped code pair 304 may include textual descriptions. A mapped code pair 304, for example, may include a textual description of the respective assessment code 306 mapped to a textual description of the respective intervention code 308.

In some embodiments, the cross-code dataset 302 may be generated by identifying one or more intervention codes 308 that correspond to each of a plurality of assessment codes 306. For example, the one or more intervention codes 308 that correspond to each of a plurality of assessment codes 306 may be identified based on a frequency distribution 310. In some examples, the number of the one or more intervention codes 308 that correspond to each of a plurality of assessment codes 306 may be based on a threshold cooccurrence value.

In some embodiments, a threshold cooccurrence value is a threshold metric associated with a frequency distribution 310. A threshold cooccurrence value, for example, may include a static and/or dynamic value, range of values, and/or the like that defines a target frequency for a code pair 314 within a frequency distribution 310. By way of example, a threshold cooccurrence value may include a static and/or dynamic percentage, such as 10%, 20%, 30%, etc., real number, such as 10, 50, 100, 1000, etc., and/or any other ratio, numeric, and/or the like. In some examples, the threshold cooccurrence value may define a relative frequency percentage, such as a top 20% frequency, for the frequency distribution 310. In such a case, the code pairs 314 with a frequency within relative frequency percentage (e.g., a top 20%) relative to other code pairs 314 within the frequency distribution 310 may satisfy the threshold cooccurrence value. In some examples, an assessment code 306 and an intervention code 308 from a code pair 314 may be mapped to each other in the event that the code pair 314 satisfies the threshold cooccurrence value.

In some embodiments, a threshold cooccurrence value is used to identify a plurality of mapped code pairs 304 conditioned on one of two code types of the code pairs 314 rather than considering the overall most frequent code pairs. For example, a threshold cooccurrence value may include a relative frequency percentage (e.g., a top 20% with respect to all code pairs 314 for a particular assessment code 306, interaction code, etc.) that is relative a plurality of code pairs 314 for a first code (e.g., an assessment code 306, etc.) shared by the plurality of code pairs 314. By way of example, a relative frequency percentage may include a relative frequency percentage, such as a top 20%, that is relative to all code pairs 314 for a particular assessment code 306. In this manner, each code pair 314 including a particular assessment code 306 may be considered together against a threshold cooccurrence value rather than considering all code pairs 314. By doing so, an increased number of mapped code pairs 304 may be generated, and issues related to relative differences in frequency may be mitigated. For example, in a case where there are many code pairs 314 including a first assessment code and few code pairs 314 including a second assessment code, identifying the overall 20% most frequent code pairs may result in none of the code pairs 314 including the second assessment code becoming mapped code pairs 304. Alternatively, if conditioned on each of the plurality of assessment codes 306, then the 20% most frequently occurring code pairs 314 including the first assessment code may be identified to become mapped code pairs 304, and additionally, the 20% most frequently occurring code pairs 314 including the second assessment code may be identified to become mapped code pairs 304.

In some embodiments, a mapped code pair 304 is a relevant code pair from a plurality of code pairs 314. For example, a mapped code pair 304 may be identified from a frequency distribution 310 in the event that the mapped code pair 304 satisfies a threshold cooccurrence value.

In some embodiments, a mapped code pair 304 includes a first textual description associated with a respective assessment code 306 and second textual description associated with a respective intervention code 308 from a respective code pair 314. A mapped code pair 304 may include any information from a respective assessment code 306 and/or intervention code 308 from the respective code pair 314. For example, mapped code pairs 304 may be used to identify which intervention codes 308 are mapped to a particular assessment code 306, by, for example, identifying one or more intervention codes 308 that are in mapped code pairs 304 with the particular assessment code 306. A mapped code pair 304 including an assessment code 306 and an intervention code 308 may also include a textual description respective to the assessment code 306 and another textual description respective to the intervention code 308. In such a case, an assessment code 306 of a mapped code pair 304 may be used to identify the textual description for an intervention code 308 of the same mapped code pair 304. Generally, information from one code in a mapped code pair 304 may be used to identify any information from the other code of the mapped code pair 304.

In some embodiments, a cross-code dataset 302 is a data entity that includes a plurality of mapped code pairs 304. A cross-code dataset 302 may be used to identify, retrieve, generate, and/or the like, any information related to the plurality of mapped code pairs 304. The cross-code dataset 302 may be used to identify information from mapped code pairs 304 based on given information. For instance, a cross-code dataset 302 may be given any information related to one code of a mapped code pair 304, and in response, identify or provide information related to the other code of the mapped code pair 304. For example, given a particular assessment code 306, one or more intervention codes 308 may be identified from mapped code pairs 304 including the particular assessment code 306. In addition, or alternatively, given a particular assessment code 306, any information related to one or more intervention codes 308 identified in mapped code pairs 304 including the particular assessment code 306 may be identified and/or provided.

In some embodiments, the cross-code dataset 302 includes a plurality of mapped code pairs 304 that are based on a plurality of interaction data objects 312 associated with a time interval. For instance, the cross-code dataset 302 may include a plurality of mapped code pairs 304 based on a plurality of code pairs 314 including information sourced from interaction data objects 312 that may be associated with a time interval. The time interval, for example, may be based on a refresh rate that defines one or more of one or more historical refresh times, one or more future refresh times, and/or a time period (e.g., a static time period, an event based time period, etc.) between two refresh times. In some examples, the cross-code dataset 302, mapped code pairs 304, code pairs 314, and/or interaction data objects 312 may be continuously or periodically refreshed to generate current data reflective of a population's current behavior. In this manner, the cross-code dataset 302, mapped code pairs 304, code pairs 314, and/or interaction data objects 312 may be adaptively changed over time to accommodate for changes within an environment.

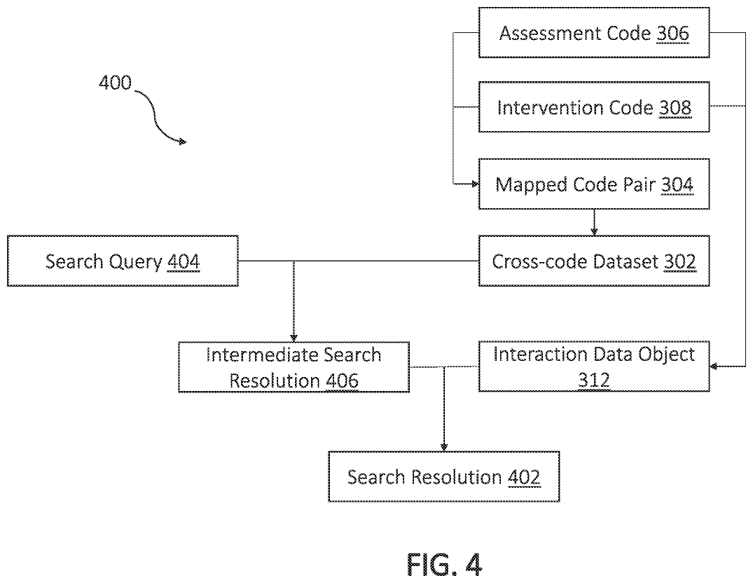

In some embodiments, as described herein, the cross-code dataset 302 is leveraged to facilitate a search query resolution for a complex search domain. For example, using the cross-code dataset 302, a query resolution operation may be performed that enables a transition of a search query of a particular type of data to a search resolution for a related type of data that solves an underlying intent of the search query rather than providing information semantically related to the search query. An example query resolution process that leverages the cross-code dataset 302 will now further be described with reference to FIG. 4.

FIG. 4 is a dataflow diagram 400 showing example data structures and modules for a query resolution operation technique in accordance with some embodiments discussed herein. The dataflow diagram 400 depicts a resolution process for generating a search resolution 402 using the cross-code dataset 302. As described herein, unlike traditional query processing techniques, the search resolution 402 may include search results of varying types of data specifically targeting an intent rather than a semantic similarity to a search query 404.

In some embodiments, the performance of a query resolution operation is initiated for a search query 404. The query resolution operation, for example, may be initiated for a search query 404 based on the cross-code dataset 302.

In some embodiments, a query resolution operation includes the initiation, execution, and/or processing of a search query 404. A search query 404 may be a search term or string from a user. A query resolution operation may be the process that executes to return to the user information determined to be most relevant to the user based on the search query 404. Information determined to be most relevant to the user may be, for example, in the form of one or more codes and/or their related information, an answer, a curated list of facts or details, a suggestion, a link, and/or the like.

In some embodiments, a cross-code dataset 302 is used in a query resolution operation to identify one or more assessment/intervention codes and/or related information to one or more assessment/intervention codes based on one or more mapped code pairs 304. For example, a user may input a search query 404, such as a diagnosis, condition, and/or assessment code 306, such as an ICD code. In response, a query resolution operation may be initiated using a cross-code dataset 302. The cross-code dataset 302 may be used to identify one or more mapped code pairs 304 associated with the search query 404. The cross-code dataset 302 may further be used to identify, based on the one or more identified mapped code pairs, a list of intervention codes 308, procedures, textual descriptions, and/or any other information based on the mapped code pairs 304. The information identified using the cross-code dataset 302 may be used as the output or part of the output of the query resolution operation. Additionally, or alternatively, the information identified using the cross-code dataset 302 may be provided for further processing. Additionally, or alternatively, the information identified using the cross-code dataset 302 may be used to identify an intermediate search resolution 406.

In some embodiments, the performance of the query resolution operation includes receiving data indicative (e.g., including identifiers, textual descriptions, etc.) of the search query 404. The search query 404, for example, may include one or more query terms input by a user, such as a diagnosis. In some examples, data indicative (e.g., including identifiers, textual descriptions, etc.) of the diagnosis input by the user may be received for further processing.

In some embodiments a search query 404 is a data entity that describes textual information indicative (e.g., textual descriptions representing, etc.) of a request for information. The textual information may be input by a user through one or more user interfaces (e.g., typed through a keyboard, etc., transcribed from one or more audio inputs, and/or the like). The search query 404 may include a plurality of query terms that are indicative (e.g., including textual descriptions representing, etc.) of one or more features of the search query 404.

In some embodiments, a query term is a data entity that describes a unit of text from a search query 404. A query term may include a keyword, phrase, and/or the like from the search query 404. By way of example, a query term may include one or more words and/or phrases extracted from the search query 404 using one or more text extraction techniques (e.g., machine learning extraction models, rule-based extraction models, and/or the like).

In some embodiments, an intermediate search resolution 406 is identified for the search query 404. The intermediate search resolution 406, for example, may be based on a comparison between one or more query terms of the search query 404 and the cross-code dataset 302.

In some embodiments, an intermediate search resolution 406 is an intermediate data entity for a query resolution operation. In some examples, an intermediate search resolution 406 includes information related to a search query 404 identified using a cross-code dataset 302. In some examples, an intermediate search resolution 406 includes information identified from a mapped code pair 304. For example, given a search query 404 that is related to a particular assessment code 306, the cross-code dataset 302 may be used to identify one or more intervention codes 308 related to the particular assessment code 306 based on one or more mapped code pairs 304 including the particular assessment code 306. In some examples, an intermediate search resolution 406 includes one or more intervention codes 308, assessment codes 306, procedures, diagnoses, textual descriptions, and/or any other information based on one or more mapped code pairs 304. The information identified in the intermediate search resolution 406 may be used as the output or part of the output of the query resolution operation. Additionally, or alternatively, the information identified in the intermediate search resolution 406 may be provided for further processing.

In some embodiments, a search resolution 402 is identified for the search query. The search resolution 402, for example, may be based on a comparison between the intermediate search resolution 406 and the plurality of interaction data objects 312.

In some embodiments, a search resolution 402 is a data entity that is an output of a query resolution operation. In some examples, a search resolution 402 includes information related to an intermediate search resolution 406 identified using one or more interaction data objects 312. In some examples, a search resolution 402 includes information identified from one or more interaction data objects.

For example, given an intermediate search resolution 406 that is related to a particular one or more intervention codes 308, assessment codes 306, procedures, diagnoses, textual descriptions, etc., one or more interaction data objects 312 may be used to identify one or more healthcare providers and/or their associated information. For instance, given an intermediate search resolution 406 including a particular intervention code 308, a plurality of interaction data objects 312 including the particular intervention code 308 may be identified. Using the plurality of identified interaction data objects, one or more healthcare providers may be identified. Then, for example, a search resolution 402 including information based on the one or more identified healthcare providers may be identified. The information identified in the search resolution 402 may be used as the output or part of the output of a query resolution operation. Additionally, or alternatively, the information identified in the search resolution 402 may be provided for further processing.

In some embodiments, data indicative (e.g., including identifiers, textual descriptions, etc.) of the search resolution 402 is provided. The data indicative (e.g., including identifiers, textual descriptions, etc.) of the search resolution 402, for example, may be provided to one or more internal systems, external systems, third parties, user devices, and/or the like.

In some examples, in a clinical domain, the cross-code dataset 302 may be used in a query resolution operation to help a user search for a procedure and/or a provider of a procedure based on a condition of the user. For example, a query resolution operation may include prompting a user to provide information related to their condition. In some examples, prompting a user to provide information related to their condition may include providing a list of interactable options, a search bar, a text prompt, and/or the like. The user may input a search query 404, for example, by selecting from a provided list or inputting a search query 404 including one or more query terms. For example, a user may input a search query 404 including an assessment code 306. A query resolution operation may include receiving data indicative (e.g., including identifiers, textual descriptions, etc.) of the search query 404.

In some examples, the query resolution operation may automatically process the search query 404 input by the user in accordance with some embodiments described herein. Alternatively, in some examples, the query resolution operation may include further prompting the user to indicate if they would like to search for a healthcare provider. For example, the query resolution operation may provide information based on a healthcare provider who is identified as providing a procedure associated with the user's assessment code 306. Based on the received input from the user, the query resolution operation may include providing information based on one or more healthcare providers identified to provide procedures associated with the assessment code 306. For example, the query resolution operation may identify an intermediate search resolution 406 based on a comparison between one or more query terms for the search query 404, such as the assessment code 306, and a cross-code dataset 302. The query resolution operation may identify a search resolution 402 based on a comparison between the intermediate search resolution 406 and a plurality of interaction data objects 312. The search resolution, for example, may include information based on one or more healthcare providers.

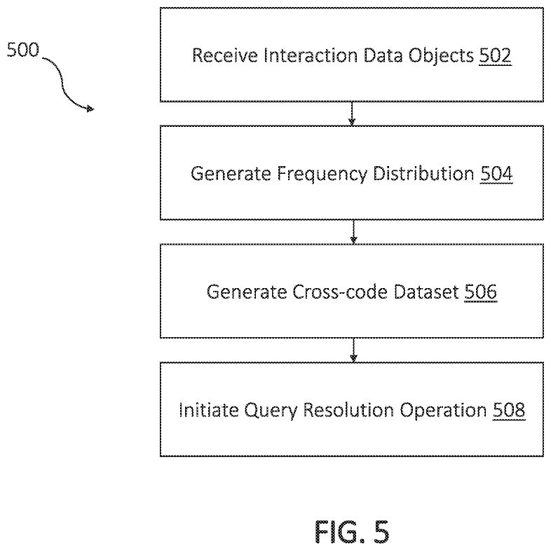

FIG. 5 is a flowchart showing an example of a process 500 for generating a cross-code dataset in accordance with some embodiments discussed herein. The flowchart depicts a mapping process for generating a cross-code dataset with mapped code pairs for improving query resolutions with respect to traditional query resolution techniques. The process 500 may be implemented by one or more computing devices, entities, and/or systems described herein. For example, via the various steps/operations of the process 500, the computing system 100 may generate, leverage, and/or monitor the performance of a cross-code dataset capable of improving query resolutions by filling information gaps, while tailoring search results to contextual details underlying a search query. By way of example, unlike traditional query resolution techniques, the cross-code dataset may be capable of mapping causal relationships, such as related assessment codes and intervention codes, and/or the like, that account for up-to-date behavioral characteristics for a population.

FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 includes, at step/operation 502, receiving interaction data objects. For example, a computing system 100 may receive a plurality of interaction data objects including a plurality of assessment codes and/or intervention codes. The plurality of interaction data objects may be associated with a time interval. The time interval, for example, may be based on a refresh rate that defines one or more of one or more historical refresh times and/or one or more future refresh times for the cross-code dataset, mapped code pairs, code pairs, and/or interaction data objects.

In some embodiments, the process 500 includes, at step/operation 504, generating a frequency distribution. For example, a computing system 100 may generate a frequency distribution for a plurality of code pairs identified within a plurality of interaction data objects.

In some embodiments, the process 500 includes, at step/operation 506, generating a cross-code dataset. For example, a computing system 100 may generate, using a frequency distribution, a cross-code dataset. The cross-code dataset, for example, may include a plurality of mapped code pairs based on a threshold cooccurrence value.

In some embodiments, the process 500 includes, at step/operation 508, initiating a query resolution operation. For example, a computing system 100 may initiate, using the cross-code dataset, a query resolution operation for a search query.

Some techniques of the present disclosure enable the generation of action outputs that may be performed to initiate one or more prediction-based actions to achieve real-world effects. The computer interpretation techniques of the present disclosure may be used, applied, and/or otherwise leveraged to generate a cross-code dataset, which may help in the computer interpretation and resolution of search queries. The cross-code dataset of the present disclosure may be leveraged to initiate the performance of various computing tasks that improve the performance of a computing system (e.g., a computer itself, etc.) with respect to various prediction-based actions performed by the computing system 100, such as for the resolution of search queries and/or the like. Example prediction-based actions may include the generation of a query resolutions tailored to a search query and/or one or more prediction-based actions derived from the query resolutions, such as the identification of a procedure (e.g., medical procedure, and/or the like) for which a prediction-based action may be initiated to automatically address.

In some examples, the computing tasks may include prediction-based actions that may be based on a search domain. A search domain may include any environment in which computing systems may be applied to achieve real-word insights, such as search predictions (e.g., query resolutions, etc.), and initiate the performance of computing tasks, such as prediction-based actions to act on the real-world insights (e.g., derived from query resolutions, etc.). These prediction-based actions may cause real-world changes, for example, by controlling a hardware component, providing alerts, interactive actions, and/or the like.

Examples of search domains may include financial systems, clinical systems, autonomous systems, robotic systems, and/or the like. Prediction-based actions in such domains may include the initiation of automated instructions across and between devices, automated notifications, automated scheduling operations, automated precautionary actions, automated security actions, automated data processing actions, and/or the like.

In some embodiments, the interpretation techniques of the process 600 are applied to initiate the performance of one or more prediction-based actions. A prediction-based action may depend on the prediction domain. In some examples, the computing system 100 may leverage the interpretation techniques to initiate the resolution of a search query, and/or the like.

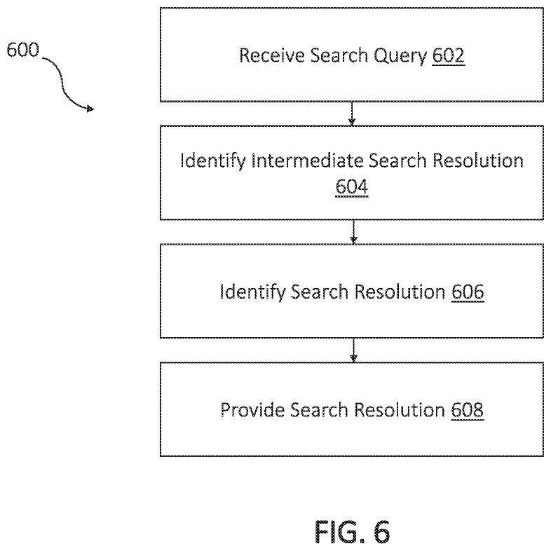

FIG. 6 is a flowchart showing an example of a process 600 for performance of a query resolution operation using a cross-code dataset in accordance with some embodiments discussed herein. The flowchart depicts a query resolution process for a query resolution operation for a search query using a cross-code dataset to overcome various limitations of traditional search query resolution techniques. The query resolution process may be implemented by one or more computing devices, entities, and/or systems described herein. For example, via the various steps/operations of the process 600, the computing system 100 may provide a search resolution using the cross-code dataset. By doing so, the computing system 100 may process a search query using the cross-code dataset to provide query resolutions for a search query. Unlike traditional search resolution techniques, the cross-code dataset may be leveraged to identify causal relationships between assessment codes and intervention codes. Moreover, unlike traditional search resolution techniques, the cross code dataset, mapped code pairs, code pairs, and/or interaction data objects may be dynamically refreshed to accommodate changes within a population over time. This, in turn, results in more accurate query resolutions that adapt with a populations behavior over time.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 602, receiving a search query. For example, the computing system 100 may receive data indicative (e.g., including identifiers, textual descriptions, etc.) of a search query. In some examples, the search query may include one or more query terms.

In some embodiments, the process 600 includes, at step/operation 604, identifying an intermediate search resolution. For example, the computing system 100 may identify an intermediate search resolution for the search query based on a comparison between one or more query terms of the search query and the cross-code dataset.

In some embodiments, the process 600 includes, at step/operation 606, identifying a search resolution. For example, the computing system 100 may identify, a search resolution for the search query based on a comparison between the intermediate search resolution and the plurality of interaction data objects.

In some embodiments, the process 600 includes, at step/operation 608, providing a search resolution. For example, the computing system 100 may provide data indicative (e.g., including identifiers, textual descriptions, etc.) of the search resolution.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method, the computer-implemented method comprising receiving, by one or more processors, a plurality of interaction data objects comprising a plurality of assessment codes and a plurality of intervention codes; generating, by the one or more processors, a frequency distribution comprising a plurality of code pairs based on a plurality of cooccurrences of the plurality of assessment codes and the plurality of intervention codes within the plurality of interaction data objects; generating, by the one or more processors and using the frequency distribution, a cross-code dataset comprising one or more mapped code pairs from the plurality of code pairs based on a threshold cooccurrence value; and initiating, by the one or more processors, the performance of a query resolution operation for a search query based on the cross-code dataset.

Example 2. The computer-implemented method of any of the preceding examples, wherein the cross-code dataset comprises a plurality of mapped code pairs and each of the plurality of mapped code pairs comprises a respective assessment code of the plurality of assessment codes and a respective intervention code of the plurality of intervention codes.

Example 3. The computer-implemented method of example 2, wherein a mapped code pair comprises a textual description of the respective assessment code mapped to a textual description of the respective intervention code.

Example 4. The computer-implemented method of any of the preceding examples, wherein generating the cross-code dataset comprises identifying one or more intervention codes that correspond to each of the plurality of assessment codes based on the frequency distribution, wherein a number of the one or more intervention codes is based on the threshold cooccurrence value.

Example 5. The computer-implemented method of any of the preceding examples, wherein the one or more mapped code pairs comprise a respective mapped code pair for each assessment code of the plurality of assessment codes.

Example 6. The computer-implemented method of any of the preceding examples, wherein the plurality of interaction data objects is associated with a time interval.

Example 7. The computer-implemented method of example 6, wherein the time interval is based on a refresh rate that defines one or more of one or more historical refresh times or one or more future refresh times for the interaction data objects.

Example 8. The computer-implemented method of any of the preceding examples, wherein the plurality of assessment codes and the plurality of intervention codes are based on one or more primary assessment codes and one or more primary intervention codes identified within each of the plurality of interaction data objects.

Example 9. The computer-implemented method of any of the preceding examples, wherein initiating the performance of the query resolution operation for the search query based on the cross-code dataset comprises: receiving data indicative of the search query; identifying an intermediate search resolution for the search query based on a comparison between one or more query terms of the search query and the cross-code dataset; identifying a search resolution for the search query based on a comparison between the intermediate search resolution and the plurality of interaction data objects; and providing data indicative of the search resolution.

Example 10. A computing system comprising memory and one or more processors communicatively coupled to the memory, the one or more processors configured to: receive a plurality of interaction data objects comprising a plurality of assessment codes and a plurality of intervention codes; generate a frequency distribution comprising a plurality of code pairs based on a plurality of cooccurrences of the plurality of assessment codes and the plurality of intervention codes within the plurality of interaction data objects; generate, using the frequency distribution, a cross-code dataset comprising one or more mapped code pairs from the plurality of code pairs based on a threshold cooccurrence value; and initiate the performance of a query resolution operation for a search query based on the cross-code dataset.

Example 11. The computing system of example 10, wherein the cross-code dataset comprises a plurality of mapped code pairs and each of the plurality of mapped code pairs comprises a respective assessment code of the plurality of assessment codes and a respective intervention code of the plurality of intervention codes.

Example 12. The computing system of example 11, wherein a mapped code pair comprises a textual description of the respective assessment code mapped to a textual description of the respective intervention code.

Example 13. The computing system of any of examples 10 through 12, wherein the one or more processors are further configured to: identify one or more intervention codes of the plurality of intervention codes that correspond to each of the plurality of assessment codes based on the frequency distribution, wherein a number of the one or more intervention codes is based on the threshold cooccurrence value.

Example 14. The computing system of any of examples 10 through 13, wherein the one or more mapped code pairs comprise a respective mapped code pair for each assessment code of the plurality of assessment codes.

Example 15. The computing system of any of examples 10 through 14, wherein the plurality of interaction data objects is associated with a time interval.

Example 16. The computing system of example 15, wherein the time interval is based on a refresh rate that defines one or more of one or more historical refresh times or one or more future refresh times for the plurality of interaction data objects.

Example 17. The computing system of any of examples 10 through 16, wherein the plurality of assessment codes and the plurality of intervention codes are based on one or more primary assessment codes and one or more primary intervention codes identified within each of the plurality of interaction data objects.

Example 18. One or more non-transitory computer-readable storage media including instructions that, when executed by one or more processors, cause the one or more processors to: receive a plurality of interaction data objects comprising a plurality of assessment codes and a plurality of intervention codes; generate a frequency distribution comprising a plurality of code pairs based on a plurality of cooccurrences of the plurality of assessment codes and the plurality of intervention codes within the plurality of interaction data objects; generate, using the frequency distribution, a cross-code dataset comprising one or more mapped code pairs from the plurality of code pairs based on a threshold cooccurrence value; and initiate the performance of a query resolution operation for a search query based on the cross-code dataset.

Example 19. The one or more non-transitory computer-readable storage media of example 18, wherein the one or more processors are further caused to: identify one or more intervention codes of the plurality of intervention codes that correspond to each of the plurality of assessment codes based on the frequency distribution, wherein a number of the one or more intervention codes is based on the threshold cooccurrence value.

Example 20. The one or more non-transitory computer-readable storage media of examples 18 or 19, wherein the cross-code dataset comprises a plurality of mapped code pairs and each of the plurality of mapped code pairs comprises a respective assessment code of the plurality of assessment codes and a respective intervention code of the plurality of intervention codes.

1. A computer-implemented method, the computer-implemented method comprising:
receiving, by one or more processors, a plurality of interaction data objects comprising a plurality of assessment codes and a plurality of intervention codes;
generating, by the one or more processors, a frequency distribution comprising a plurality of code pairs based on a plurality of cooccurrences of the plurality of assessment codes and the plurality of intervention codes within the plurality of interaction data objects;
generating, by the one or more processors and using the frequency distribution, a cross-code dataset comprising one or more mapped code pairs from the plurality of code pairs based on a threshold cooccurrence value; and
initiating, by the one or more processors, the performance of a query resolution operation for a search query based on the cross-code dataset.

2. The computer-implemented method of claim 1, wherein the cross-code dataset comprises a plurality of mapped code pairs and each of the plurality of mapped code pairs comprises a respective assessment code of the plurality of assessment codes and a respective intervention code of the plurality of intervention codes.

3. The computer-implemented method of claim 2, wherein a mapped code pair comprises a textual description of the respective assessment code mapped to a textual description of the respective intervention code.

4. The computer-implemented method of claim 1, wherein generating the cross-code dataset comprises:
identifying one or more intervention codes of the plurality of intervention codes that correspond to each of the plurality of assessment codes based on the frequency distribution, wherein a number of the one or more intervention codes is based on the threshold cooccurrence value.

5. The computer-implemented method of claim 1, wherein the one or more mapped code pairs comprise a respective mapped code pair for each assessment code of the plurality of assessment codes.

6. The computer-implemented method of claim 1, wherein the plurality of interaction data objects is associated with a time interval.

7. The computer-implemented method of claim 6, wherein the time interval is based on a refresh rate that defines one or more of one or more historical refresh times or one or more future refresh times for the plurality of interaction data objects.

8. The computer-implemented method of claim 1, wherein the plurality of assessment codes and the plurality of intervention codes are based on one or more primary assessment codes and one or more primary intervention codes identified within each of the plurality of interaction data objects.

9. The computer-implemented method of claim 1, wherein initiating the performance of the query resolution operation for the search query based on the cross-code dataset comprises:
receiving data indicative of the search query;
identifying an intermediate search resolution for the search query based on a comparison between one or more query terms of the search query and the cross-code dataset;
identifying a search resolution for the search query based on a comparison between the intermediate search resolution and the plurality of interaction data objects; and
providing data indicative of the search resolution.

10. A computing system comprising memory and one or more processors communicatively coupled to the memory, the one or more processors configured to:
receive a plurality of interaction data objects comprising a plurality of assessment codes and a plurality of intervention codes;
generate a frequency distribution comprising a plurality of code pairs based on a plurality of cooccurrences of the plurality of assessment codes and the plurality of intervention codes within the plurality of interaction data objects;
generate, using the frequency distribution, a cross-code dataset comprising one or more mapped code pairs from the plurality of code pairs based on a threshold cooccurrence value; and
initiate the performance of a query resolution operation for a search query based on the cross-code dataset.

11. The computing system of claim 10, wherein the cross-code dataset comprises a plurality of mapped code pairs and each of the plurality of mapped code pairs comprises a respective assessment code of the plurality of assessment codes and a respective intervention code of the plurality of intervention codes.

12. The computing system of claim 11, wherein a mapped code pair comprises a textual description of the respective assessment code mapped to a textual description of the respective intervention code.

13. The computing system of claim 10, wherein the one or more processors are further configured to:
identify one or more intervention codes of the plurality of intervention codes that correspond to each of the plurality of assessment codes based on the frequency distribution, wherein a number of the one or more intervention codes is based on the threshold cooccurrence value.

14. The computing system of claim 10, wherein the one or more mapped code pairs comprise a respective mapped code pair for each assessment code of the plurality of assessment codes.

15. The computing system of claim 10, wherein the plurality of interaction data objects is associated with a time interval.

16. The computing system of claim 15, wherein the time interval is based on a refresh rate that defines one or more of one or more historical refresh times or one or more future refresh times for the plurality of interaction data objects.

17. The computing system of claim 10, wherein the plurality of assessment codes and the plurality of intervention codes are based on one or more primary assessment codes and one or more primary intervention codes identified within each of the plurality of interaction data objects.

18. One or more non-transitory computer-readable storage media including instructions that, when executed by one or more processors, cause the one or more processors to:
receive a plurality of interaction data objects comprising a plurality of assessment codes and a plurality of intervention codes;
generate a frequency distribution comprising a plurality of code pairs based on a plurality of cooccurrences of the plurality of assessment codes and the plurality of intervention codes within the plurality of interaction data objects;
generate, using the frequency distribution, a cross-code dataset comprising one or more mapped code pairs from the plurality of code pairs based on a threshold cooccurrence value; and
initiate the performance of a query resolution operation for a search query based on the cross-code dataset.

19. The one or more non-transitory computer-readable storage media of claim 18, wherein the one or more processors are further caused to:
identify one or more intervention codes of the plurality of intervention codes that correspond to each of the plurality of assessment codes based on the frequency distribution, wherein a number of the one or more intervention codes is based on the threshold cooccurrence value.

20. The one or more non-transitory computer-readable storage media of claim 18, wherein the cross-code dataset comprises a plurality of mapped code pairs and each of the plurality of mapped code pairs comprises a respective assessment code of the plurality of assessment codes and a respective intervention code of the plurality of intervention codes.
